(19) United States
(12) Patent Application Publication
(10) Pub. No.: US 2011/0200243 A1
(43) Pub. Date: Aug. 18, 2011

(54) MAGNETIC RESONANCE IMAGING APPARATUS AND METHOD

(75) Inventors: Masahiro Takizawa, Tokyo (JP); Tetsuhiko Takahashi, Tokyo (JP); Masayuki Isobe, Tokyo (JP); Chang Beom Ahn, Seoul (KR); Jeong-IL Park, Gyeonggi-do (KR)

(73) Assignee: Hitachi Medical Corporation, Tokyo (JP)

(21) Appl. No.: 13/124,527

(22) PCT Filed: Oct. 13, 2009
(86) PCT No.: PCT/JP2009/067697

§ 371 Date: Apr. 15, 2011

(30) Foreign Application Priority Data
Oct. 20, 2008 (JP) 2008-269263

(51) Int. Cl. G06K 9/20

(52) U.S. Cl. 382/131

(57) ABSTRACT

Disclosed is a magnetic resonance imaging apparatus comprising static magnetic field generation means, gradient magnetic field generation means, high-frequency magnetic field generation means, reception means, signal processing means, and control means which controls the gradient magnetic field generation means, the high-frequency magnetic field generation means, the reception means, and the signal processing means, wherein said apparatus comprises: approximation means that approximates the output error of the gradient magnetic field using a combination of multiple parameter values with respect to each direction of the gradient magnetic field; evaluation means that evaluates the combinations of multiple parameter values based on the image quality of a magnetic resonance image that is reconstructed while taking into account the output error of the gradient magnetic field that has been approximated by the approximation means; and determination means that, based on the result of the evaluation by the evaluation means, determines a desired combination among the combinations of multiple parameter values.

### FIELD OF THE INVENTION

The present invention relates to a magnetic resonance imaging (hereinafter referred to as MRI) apparatus and method, in particular to the technique for appropriately reducing artifacts which occur due to output error of a gradient magnetic field.

### DESCRIPTION OF RELATED ART

An MRI apparatus comprises a static magnetic field generation device for generating a homogeneous static magnetic field in an imaging space; a gradient magnetic field coil for generating a gradient magnetic field in an imaging space; and a high-frequency coil for generating a high-frequency magnetic field in an imaging space, for applying a high-frequency magnetic field from a high-frequency magnetic field coil to an examination region of an object to be examined placed in a homogeneous static magnetic field space, detecting a nuclear magnetic resonance (hereinafter referred to as NMR) signal produced from the examination region, and imaging the detected signals so as to obtain an image which is effective for diagnosis. The gradient magnetic field coil applies the gradient magnetic field of which the magnetic field intensity is varied in orthogonal three axes directions to an imaging space so as to append positional information to NMR signals.

In an MRI apparatus, when an error is caused in the output of a gradient magnetic field, inhomogeneity is produced in the acquired echo signal which leads to distortion of image and generation of artifacts. Here, the output error of a gradient magnetic field refers to the difference between the application amount of the gradient magnetic field pulse being set at the setting of a sequence and the amount of the gradient magnetic field pulse to be actually outputted (the amount of the gradient magnetic field given to a spin of the examination region (hydrogen nucleus, etc.)), and includes various factors such as inhomogeneity of a static magnetic field, offset of a gradient magnetic field, and deviation of rise time (or fall time) in the output of a gradient magnetic field due to eddy current.

From among these factors, shimming or offset adjustment is often incorporated as pre-scan, since inhomogeneity of a static magnetic field or offset of a gradient magnetic field is less likely to vary with respect to a sequence or imaging parameters and can be calculated in advance for correction. However, since temporal deviation of an eddy current or the output of a gradient magnetic field often vary by the sequence or imaging parameters, it is difficult to calculate the deviation in advance for correction.

Especially, in the spiral method which is one of the nonorthogonal sampling methods of an MRI apparatus, since the scan directions in the measurement space are in parallel in a specific direction, output error of a gradient magnetic field affects in various directions in the measurement space. In Non-patent Document 1, output error of a gradient magnetic field is corrected by approximating it by an equivalent circuit and modeling the echo signal coordinates placed on the measurement space by determining each parameter value of the equivalent circuit.

### PRIOR ART DOCUMENT

Non-patent Document 1: S. H. Cho et al., Compensation of eddy current by an R-L-C circuit model of the gradient system, Proc. Intl. Soc. Mag. Reson. Med. 16: 1156 (2008)

However, the fact that the output error of the gradient magnetic field is different in each gradient magnetic fields of X, Y and Z necessary for image generation in a magnetic resonance imaging apparatus is not taken into consideration in Non-patent Document 1. Also, the method for effectively acquiring each parameter value of the equivalent circuit is not disclosed therein.

The objective of the present invention is to provide the magnetic resonance imaging apparatus and the method capable of effectively reducing artifacts generated depending on the output error of gradient magnetic fields.

### BRIEF SUMMARY OF THE INVENTION

In order to achieve the above-described objective, the present invention is capable of determining the combination of desired parameters reflecting the error of the gradient magnetic field, since the output error of the gradient magnetic field is approximated using the combination of multiple parameter values for the respective three kinds of the gradient magnetic fields, the combination of the multiple parameter values is evaluated based on the image quality of the magnetic resonance image reconstructed taking into consideration the output error of the gradient magnetic field approximated by the approximation means, and a desired combination of the multiple parameter values is respectively evaluated and determined so as to obtain the desired evaluation result.

More concretely, since the desired combination of parameter values can be acquired while discretely varying the combination of the parameter values, it is possible to optimize the man-hour in acquiring the desired combination of parameter values.

### Effect of the Invention

In accordance with the present invention, it is possible to provide the magnetic resonance imaging apparatus and the method capable of reducing artifacts generated depending on the output error of gradient magnetic fields.

### BRIEF DESCRIPTION OF THE DRAWINGS

FIG. 1 is a block diagram showing an example of general configuration of an MRI apparatus to which the present invention is applied.

FIG. 2 shows the pulse sequence of the spiral method as an example of the non-orthogonal sampling method.

FIG. 3 shows the result of arranging the sampled data in the measurement space using the pulse sequence in FIG. 2.

FIG. 4 shows the imaging procedure of the non-orthogonal sampling method.

FIG. 5 shows an equivalent circuit using two resistances R₁ and R₂, condenser C and coil L.

FIG. 6 shows an example of first readout gradient magnetic field pulse 204.

FIG. 7 shows, after approximating the error of a gradient magnetic field pulse waveform as shown in FIG. 6 using an RCRL equivalent circuit with respect to first and second readout gradient magnetic field pulses 204 and 205, calculation of the actual coordinate of the echo signal on the measurement space using the approximated gradient magnetic field pulse waveform.

FIG. 8 shows the difference of image quality between with and without the equivalent circuit.

FIG. 9 shows the general flow of the processing for determining the parameter value of the equivalent circuit by pre-measurement.

FIG. 10 is a flowchart showing the procedure in step 903 for detecting the parameter value of a desired equivalent circuit.

FIG. 11 shows a concrete example for changing and setting equivalent circuit parameter values.

FIG. 12 shows the detail of the process in 1002 of FIG. 10.

FIG. 13 shows an example of the criteria for determining image quality.

FIG. 14 is for explaining a flow for applying the determined parameter of the equivalent circuit to the present measurement.

FIG. 15 is for explaining the flow in embodiment 2.

FIG. 16 shows the chart equivalent to FIG. 9 in embodiment 1.

FIG. 17 shows the chart equivalent to FIG. 10 in embodiment 1.

FIG. 18 shows a screen referring to the image that changes along with the parameter value.

### DETAILED DESCRIPTION OF THE INVENTION

An embodiment of the present invention will be described below based on the attached drawings. In all of the drawings for explaining the invention, the same function parts are represented by the same reference numerals, and the duplicative description thereof is omitted.

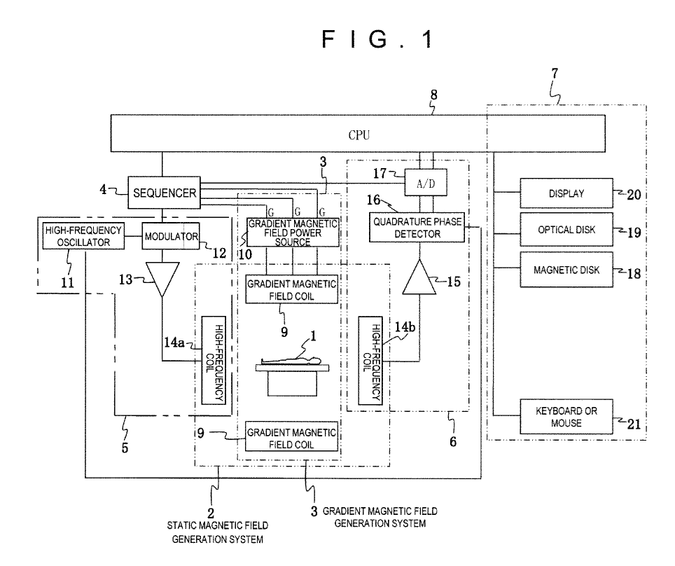

FIG. 1 is a block diagram showing the general configuration of an example of the MRI apparatus to which the present invention is applied. The MRI apparatus is for obtaining a tomographic image of an object to be examined using NRM phenomenon, and comprises static magnetic field generation system 2, gradient magnetic field generation system 3, transmission system 5, reception system 6, signal processing system 7, sequencer 4 and central processing unit (CPU) 8 as shown in FIG. 1.

Static magnetic field generation system 2 generates a homogeneous static magnetic field in the space around object 1 in the body-axis direction or the direction orthogonal to the body axis, and magnetic field generation means of the permanent magnetic method, normal conducting method or the super-conducting method is placed around object 1.

Gradient magnetic field generation system 3 is formed by gradient magnetic field coil 9 for generating a gradient magnetic field in 3 axis-directions of X, Y and Z and gradient magnetic field power source 10 for driving the respective gradient magnetic field coils, and applies gradient magnetic fields Gs, Gp and Gf to object 1 in 3 axis-directions of X, Y and Z by driving gradient magnetic field power source 10 of the respective coils according to the command from sequencer 4 to be hereinafter described. More concretely, gradient magnetic field generation system 3 sets the slice plane with respect to object 1 by applying slice-direction gradient magnetic field pulse (Gs) in any one direction of X, Y and Z, applies phase encode direction gradient magnetic field pulse (Gp) and frequency encode direction gradient magnetic field pulse (Gf) in the remaining two directions, and encodes the positional information of the respective directions to the echo signal.

Sequencer 4 is control means for repeatedly applying a high-frequency magnetic field pulse (hereinafter referred to as “RF pulse”) and a gradient magnetic field pulse at a predetermined pulse sequence, which operates under control of CPU 8, and transmits various commands necessary for data collection of a tomographic image of object 1 to transmission system 5, gradient magnetic field generation system 3 and reception system 6.

Transmission system 5 is for irradiating an RF pulse for producing nuclear magnetic resonance to nuclear spin of atomic elements configuring biological tissues of object 1, and is formed by high-frequency oscillator 11, modulator 12, high-frequency amplifier 13 and high-frequency coil 14a on the transmission side. The high-frequency pulse outputted from high-frequency oscillator 11 is amplitude-modulated by modulator 12 at the timing commanded from sequencer 4, the amplitude-modulated high-frequency pulse is amplified by high-frequency amplifier 13 to be provided to high-frequency coil 14a placed in the vicinity of object 1, and the electromagnetic wave (RF pulse) is irradiated to object 1. Reception system 6 is for detecting the echo signal (NMR signal) eradiated by nuclear magnetic resonance of nuclear spins forming the biological tissues of object 1, and is formed by high-frequency coil 14b on the reception side, amplifier 15, quadrature phase detector 16, and A/D converter 17. The responsive electromagnetic wave (NMR signal) of object 1 excited by the electromagnetic wave irradiated from high-frequency coil 14a on the transmission side is detected by high-frequency coil 14b placed in the vicinity of object 1, amplified by amplifier 15, divided into orthogonal diphyletic signals by quadrature phase detector 16 at the timing commanded from sequencer 4, converted into a digital amount respectively by A/D converter 17, and transmitted to signal processing system 7.

Signal processing system 7 has an external storage device such as optical disk 19 or magnetic disk 18, display 20 such as a CRT and a keyboard or a mouse. When the data from reception system 6 is inputted from CPU 8, CPU 8 executes the processing such as signal processing and image reconstruction, displays the tomographic image of object 1 which is the result of the processing on display 20, and stores the image in magnetic disk 18, etc. of the external storage device.

In FIG. 1, high-frequency coils 14a and 14b on the transmission side and the reception side and gradient magnetic field coil 9 are disposed in a static magnetic field space of static magnetic field system 2 placed in the space around object 1.

Currently the kind of imaging target spin being clinically used is proton that is the main constituent of object 1. The function or figuration of a body part such as a head region, abdominal region or extremities is two-dimensionally or three-dimensionally imaged by imaging the spatial distribution of proton density or spatial distribution of relaxation phenomenon of the excitation state.

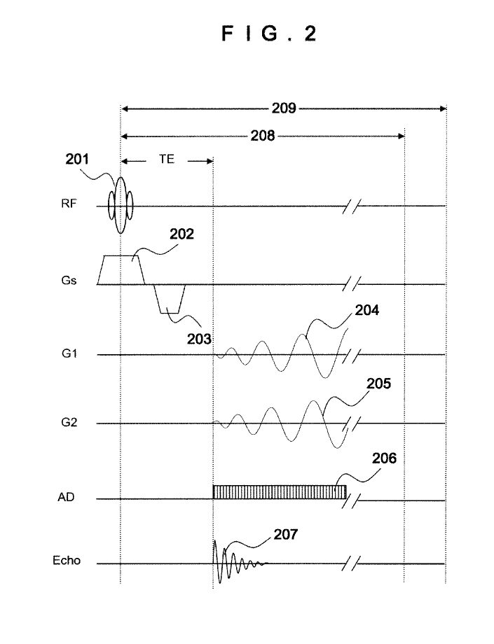

Next, the imaging method to be implemented in the above-mentioned MRI apparatus will be described. FIG. 2 shows a pulse sequence of the spiral method as an example of the non-orthogonal sampling method. The RF, Gs, G1, G2, A/D and echo in FIG. 2 respectively represents an RF pulse, slice gradient magnetic field, readout gradient magnetic field in a first direction, readout gradient magnetic field in a second direction, sampling of A/D conversion and the axis of the echo signal. An RF pulse is indicated by 201, a slice-selecting gradient magnetic field pulse is indicated by 202, a slice-rephase gradient magnetic field pulse is indicated by 203, a first readout gradient magnetic field pulse is indicated by 204, a second readout gradient magnetic field pulse is indicated by 205, a sampling window is indicated by 206, an echo signal is indicated by 207 and repetition time (interval of RF pulse 201) is indicated by 208 (refer to “High-Speed Spiral-Scan Echo Planar NMR Imaging-I” C. B. AHN et al., IEEE TRANSACTIONS ON MEDICAL IMAGING. VOL. MI-5, No. 1, MARCH 1986 as a common technique related to the spiral method).

In the spiral method, there are cases that all of the data necessary for image construction is acquired in one repetition time 208 and that the data acquisition is executed by dividing the repetition time into plural times. In the latter case, the data necessary for reconstructing one piece of image is obtained in image acquisition time 209 by changing the output of first and second readout gradient magnetic field pulses 204 and 205 little at a time for each repetition time 208. In order to acquire the data in whorls, an example of the waveform of the first and second (for example, X-axis and Y-axis) readout gradient magnetic field pulses can be expressed by:

G₁(t)=η cos τt−ηξt sin ξt

G₂(t)=η sin ξt+ηξt cos ξt (1)

(Here, η, ξ are respectively constant numbers). In equation (1), however t represents time.

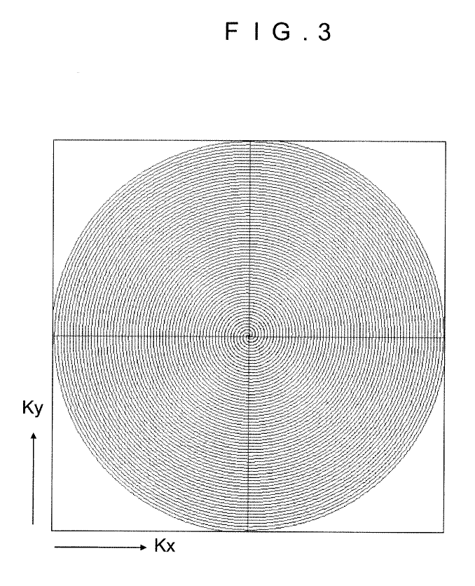

FIG. 3 shows the result of arranging the data sampled using the pulse sequence in FIG. 2 in the measurement space. In MRI, the relationship between the output of the readout gradient magnetic field and the coordinate wherein the echo signal is placed in the measurement space is expressed as the following equation (γ is gyromagnetic ratio).

k(t)=γƒ₀^{t}G(t′)dt′ (2)

From equation (1) and equation (2), the coordinate wherein the echo signal is arranged on the measurement space can be expressed by the following equation.

kₓ(t)=γηt cos ξt

k_{y}(t)=γηt sin ξt (3)

Since the vertical axis is generally described as Y and the horizontal axis is described as X in the measurement space, G₁ and G₂ of equation (1) are respectively replaced with Gₓ and G_{y}.

In MRI, since fast Fourier transform is used for image reconstruction, coordinates in the measurement space are expressed by integers. However, the coordinates calculated in equation (3) is not necessarily the integer value. Given this factor, the data is converted into the coordinate expressed by integers from the non-integral coordinates using the interpolation processing referred to as gridding (for example, refer to “Selection of a Convolution Function for Fourier Inversion Using Gridding”, John I. Jackson, IEEE TRANSACTIONS ON MEDICAL IMAGING, VOL. 10, NO. 3, SEPTEMBER 1991, 473-478 as a common example related to gridding).

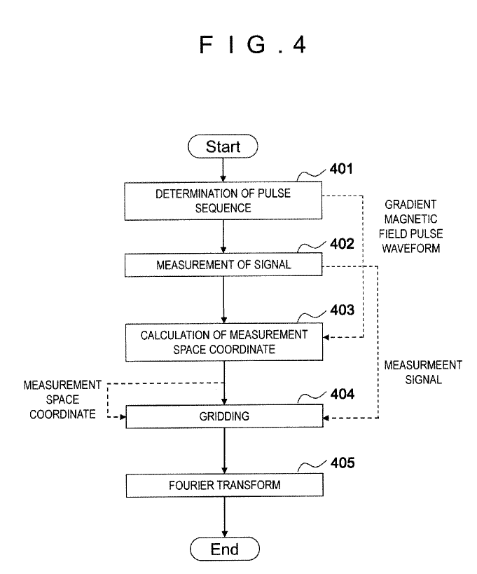

Next, imaging procedure of the non-orthogonal sampling method shown in FIG. 4 will be described below.

(Step 401)

First, a pulse sequence is set by an operator and the apparatus. In concrete terms, in the case of spiral scanning, the operator inputs the number of sampling at the time of collecting the data of the echo signal by an A/D converter for collecting one echo signal and the parameter value such as the number of spiral scanning necessary for filling the measurement space, via input means such as a keyboard or mouse 21 in FIG. 1. Then the waveform of the gradient magnetic field pulse is calculated using equation (1) and the pulse sequence is set by the apparatus as seen in the sequence diagram shown in FIG. 2.

(Step 402)

Next, imaging is executed according to the pulse sequence set in step 401 by the apparatus, and the echo signal is calculated.

(Step 403)

CPU 8 calculates the coordinate on the measurement space of the echo signal acquired when the imaging of the pulse sequence set in step 401 is executed using equation (3).

(Step 404)

After the echo signal acquired in step 402 is arranged at the coordinate on the measurement space acquired in step 403, the measurement space data wherein the value is rearranged at the lattice-shaped position by the gridding process is created.

(Step 405)

An image is generated by executing two-dimensional Fourier transform on the measurement space created in step 404.

However, when the output error of the gradient magnetic field is caused as described in the section of prior arts above, since the coordinates wherein the echo signal is to be arranged on the measurement space include the error, the artifact due to the gradient magnetic field error is generated.

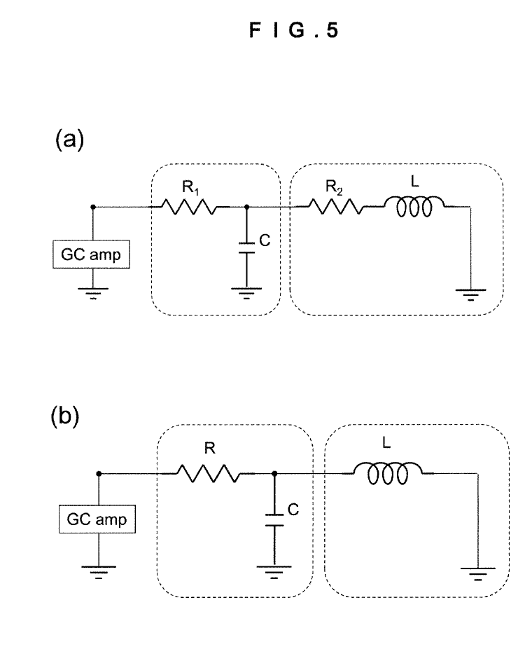

In non-patent document 1, the system response of the gradient magnetic field output is corrected by approximation using an equivalent circuit. The method disclosed in Non-patent Document 1 will be described below. FIG. 5 shows equivalent circuits using two resistors R₁ and R₂, condenser C and coil L (hereinafter referred to as RCRL equivalent circuit). In concrete terms, the equivalent circuit in FIG. 5(a) models the gradient magnetic field generation system by resisters and a condenser, and models the inductance of the gradient magnetic field coil including the mutual inductance between the gradient magnetic field coil and the main coil by reactor L, as disclosed in Non-patent Document 1. In other words, in the RCRL equivalent circuit, two resistors (R₁ and R₂) and reactor L are series-connected to the other end of an alternator of which one end is connected to a ground and the other end of the reactor is connected to a ground, while the connection point of the two resistors is connected to the condenser and the other end of the condenser is connected to a ground.

In Non-patent Document 1, the output error of the gradient magnetic field is approximated by expressing it by the transfer function expressed by the equivalent circuit. Here, the transfer function of the equivalent circuit in FIG. 5(a) is expressed as below, as disclosed in Non-Patent Document 1.

$$H ( s ) = \frac{1}{( {R}_{1} LC ) {s}^{2} + ( {R}_{1} {R}_{2} C + L ) s + ( {R}_{1} + {R}_{2} )} \qquad ( 4 )$$

Function h(t) wherein inverse Laplace transform is executed on the transfer function H(s) is expressed as the following equation:

$$h ( t ) = \frac{1}{ω m} {e}^{- a t} sin ω t , \qquad ( 5 )$$

wherein:

$$\{ \begin{matrix}m = {R}_{1} LC \\ c = {R}_{1} {R}_{2} C + L \\ k = {R}_{1} + {R}_{2} \\ a = \frac{c}{2 m} \\ D = {c}^{2} - 4 mk \\ ω = \frac{\sqrt{- D}}{2 m} .\end{matrix} \qquad ( 6 )$$

By performing convolution operation of the above-calculated function h(t) on the output of gradient magnetic field set by the sequencer, the output of gradient magnetic field including the error element of the gradient magnetic field is calculated. Also, FIG. 5(b) shows another example of the equivalent circuit, which is the equivalent circuit respectively formed by one resistor R, condenser C and coil L (hereinafter referred to as RCL equivalent circuit). Such configured equivalent circuits are capable of approximating the output including the error element of the gradient magnetic field. More concretely, in the above-mentioned RCL equivalent circuit, one resistor (R) and reactor L are series-connected to one end of the alternator of which the other end is connected to a ground and the other end of the reactor L is connected to a ground, while the connection point between one resistor and the reactor is connected to the condenser and the other end of the condenser is connected to the ground.

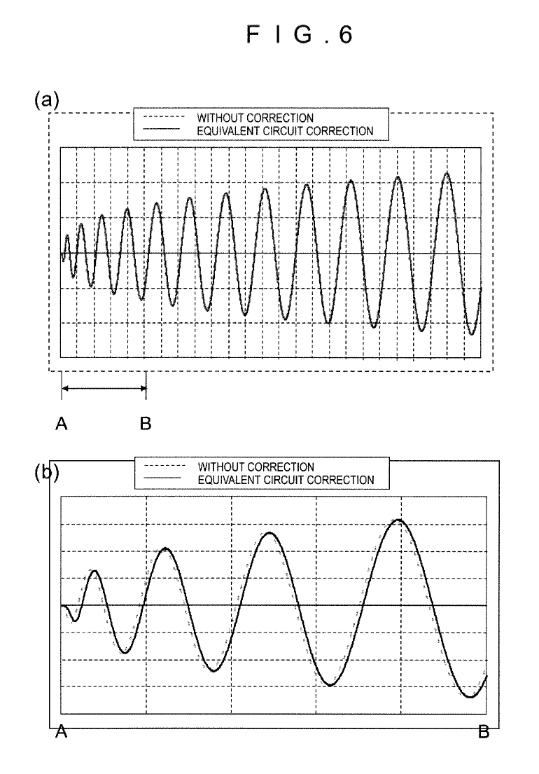

FIG. 6(a) is an example of first readout gradient magnetic field pulse 204, which is the actual gradient magnetic field pulse including the error, approximated using the gradient magnetic field pulse waveform outputted from the sequencer which is indicated by a dotted line and the RCRL indicated by a solid line. FIG. 6(b) is an enlarged view of the region indicated by A-B in the waveform shown in FIG. 6(a). It is recognizable from these diagrams that the error of the gradient magnetic field pulse is approximated by the equivalent circuit.

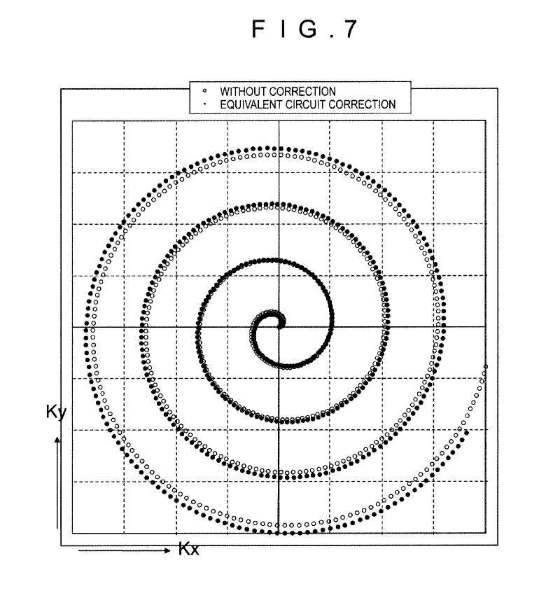

FIG. 7 shows, after approximating the error of a gradient magnetic field pulse waveform as shown in FIG. 6 using an RCRL equivalent circuit with respect to first and second readout gradient magnetic field pulses 204 and 205, calculation of the actual coordinates of the echo signal on the measurement space using the approximated gradient magnetic field pulse waveform. The white circles in the diagram indicate the coordinates before correction by the equivalent circuit, and the black circles indicate the coordinates after correction. Such deviation of the coordinates in the measurement space leads to lowering of imaging performance. Given this factor, the deviation of the coordinates on the measurement space is corrected in Non-patent Document 1 by approximation using the RCRL equivalent circuit. In concrete terms, an image is obtained by executing two-dimensional Fourier transform, after arranging echo signal on the coordinates indicated by black circles in FIG. 7.

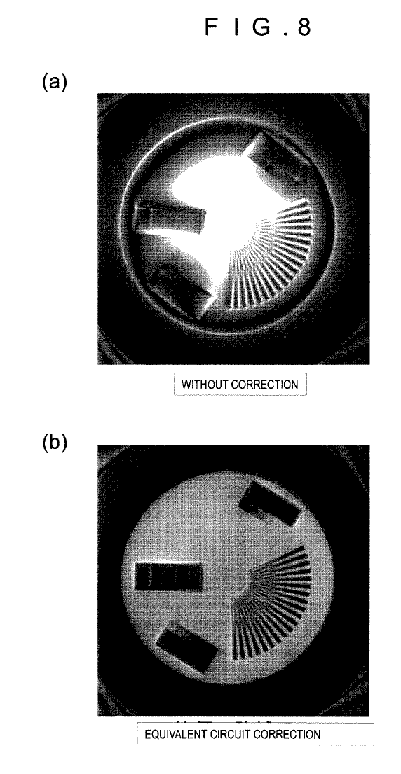

FIG. 8 shows the difference of image quality between the images with and without the equivalent circuit. In the image shown in FIG. 8(a) without correction, imaging performance is significantly lowered and the ring-shaped structure is recognized therein. In the image shown in FIG. 8(b) using the equivalent circuit, imaging performance is drastically improved and detailed structure of the image can be recognized. In this manner, correction using an equivalent circuit is effective in the spiral method, the output error of the gradient magnetic field causes drastic deterioration of image quality.

### Embodiment 1

While considering the above-described image improvement method in the spiral method, a first embodiment of the MRI apparatus related to the present invention will be described. In the present embodiment, the parameter value of the equivalent circuit is acquired by pre-measurement, and data correction is executed in the actual measurement using the acquired parameter.

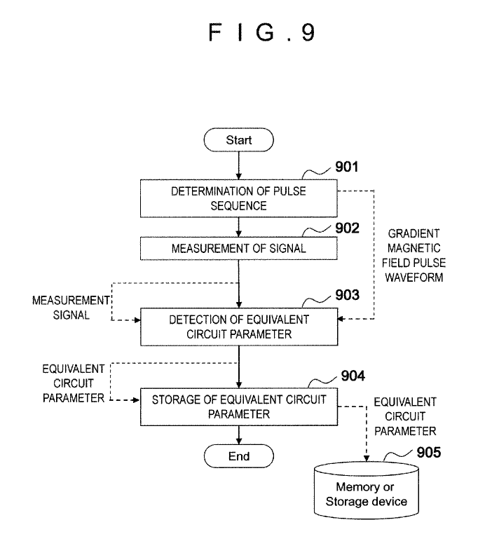

FIG. 9 is a general flow of the process for determining the parameter value of the equivalent circuit by pre-measurement.

### (Step 901)

Setting of the reference pulse sequence is executed. Basically, processing such as parameter setting in the present step is the same as step 401 in FIG. 4.

(Step 902)

The pulse sequence set in step 901 is executed and the echo signal from the phantom is measured.

(Step 903)

A search is done for the desired equivalent circuit parameter. More specifically, an image is generated by arranging the echo signal measured in step 902 on the coordinates in the measurement space acquired by the parameter value in the above-mentioned equivalent circuit, and a search is done for the parameter value wherein the profile of the good phantom can be obtained on the image by changing the parameter.

(Step 904)

The parameter value of the equivalent circuit searched in step 903 is stored in memory or storage device 905.

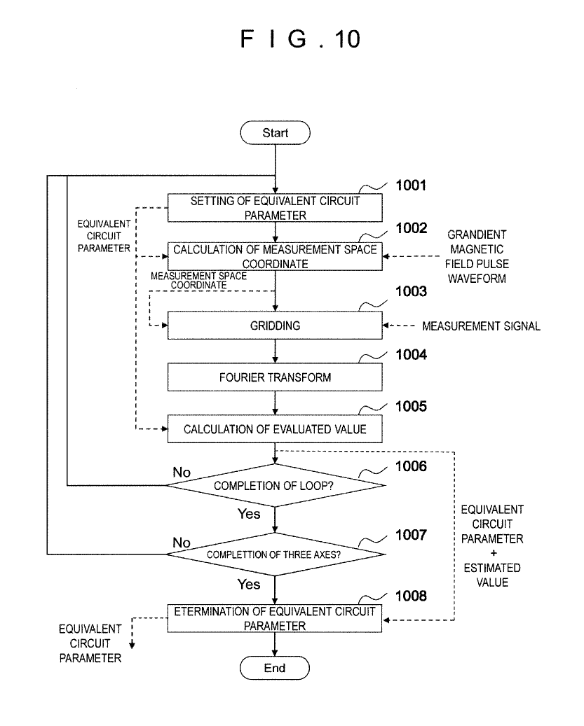

The procedure for searching the parameter value of a desired equivalent circuit in step 903 will be described using the flowchart in FIG. 10.

(Step 1001)

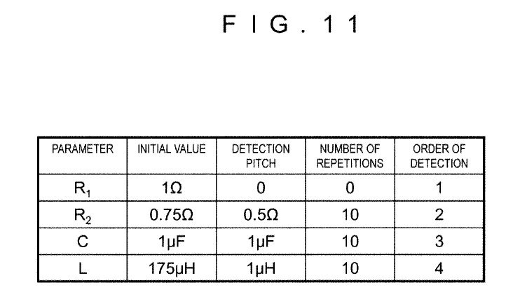

The equivalent circuit parameter value is set. The initial value of the respective parameters is set at search starting time, and the equivalent circuit parameter value is set by changing it at a predetermined pitch during the search. FIG. 11 is a chart showing a concrete example of the search. In this example, while R₁, C and L are respectively fixed as 1Ω, 1 μF and 175 μH, R₂ is set for 10 times from 0.75Ω at 0.05Ω pitch (0.75Ω, 0.80Ω, . . . , 1.20Ω) so as to obtain a desired parameter value having a good evaluated value to be hereinafter described. Next, while R₁, R₂ and L are respectively fixed as 1Ω, the obtained desired parameter value and 175 μH, C is set for 10 times from 1 μF at 1 μF pitch (1 μF, 2 μF, . . . , 10 μF) so as to obtain a desired parameter value. Finally, while R₁ is fixed as 1Ω and R₂ and C are fixed as the desired parameter values, L is set for 10 times from 175 μH at 1 μH pitch (175 μH, 176 μH, . . . , 184 μH) so as to obtain a desired parameter value. In the parameter value setting of the present step however, the setting is to be sequentially executed with respect to the parameter value for each direction of X-axis, Y-axis and Z-axis of the gradient magnetic field necessary in the MRI apparatus.

(Step 1002)

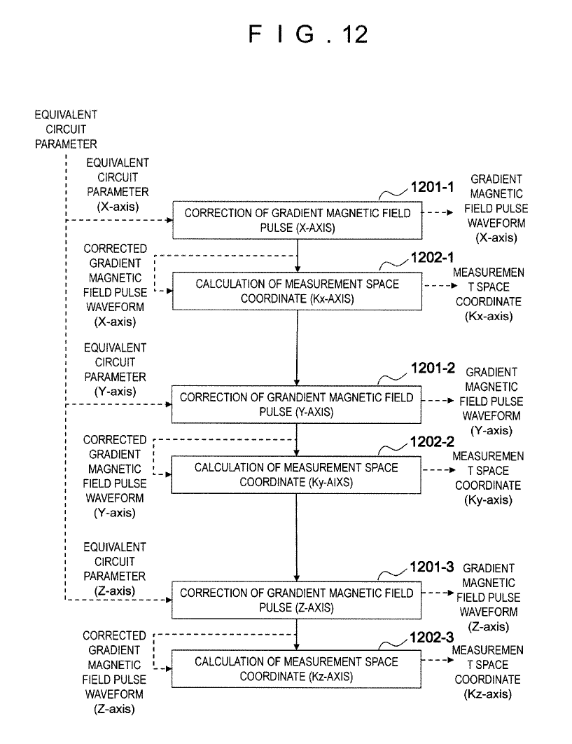

The coordinates on the measurement space of the echo signal is calculated based on the gradient magnetic field pulse waveform (created in step 901 of FIG. 9) including the actual error approximated using the parameter value of the respective equivalent circuits set in step 1001. The detail of the process thereof will be described later using FIG. 12.

(Step 1003)

Using the echo signal acquired in step 902 and the coordinates on the measurement space calculated in step 1002, the measurement space data is created wherein the value is rearranged on the lattice-like position by the gridding process.

(Step 1004)

An image is generated by Fourier transforming the measurement space data which is processed with gridding.

(Step 1005)

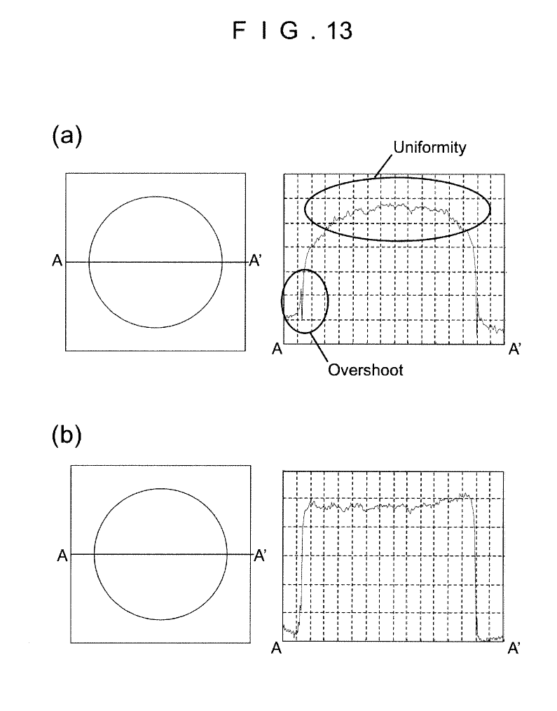

Improvement of image quality by the equivalent circuit is evaluated based on the generated image. FIG. 13 is an example of the criteria for determining the image quality. FIG. 13(a) is the case of the combination with the parameter value of the equivalent circuit, and FIG. 13(b) is the case of the other combination. The left side of the diagram indicates the image, and the right side indicates the signal intensity profile of the A-A′ line. Since this image is the phantom that is uniform, the ideal signal intensity profile has a constant signal value in the region where the phantom exists. However, the signal moves up at the edge of phantom in FIG. 13(a). The signal moves up high in the center area of the phantom region, and it drops down as it gets toward the outer side. At this time, the value is calculated for each parameter value of the equivalent circuit by defining the upward movement of the signal at the edge as “overshoot” and the evenness of the signal in the inner phantom as “uniformity”. For example, the average value or the maximum value of the signal within the ROI set on the edge may be used for the “overshoot”, and the standard deviation of the signal within the ROI set in the phantom may be used for the “uniformity”. In other words, evaluation of the plurality of parameter values is executed in the present step based on the flatness of the magnetic resonance image of the phantom, etc.

(Step 1006)

Whether all of the combinations of the parameter values of the equivalent circuit are calculated is determined. For example, in the case of the RCRL equivalent circuit shown in FIG. 5(a), a desired value is searched by respectively changing R₁, R₂, C and L which configure the equivalent circuit for predetermined times.

When it is determined in the present step that all of the combinations of the parameter values are not calculated, steps 1001˜1005 are to be repeated again. When all of the combinations are calculated, step 1007 is carried out.

(Step 1007)

Whether the search for the parameter value of the equivalent circuit is completed in all axes of the gradient magnetic field is determined. As for the order of the axes for searching the parameter value, for example, it is executed in order of X, Y and Z-axis of the gradient magnetic field. However, the order for searching the parameter value is not limited thereto, and a desired order can be determined in accordance with the hardware configuration of the apparatus. When the result is “No” in the step, steps 1001˜1006 are to be repeated again. If the result is “Yes”, step 1008 is to proceed. In order to search the parameter value of the equivalent circuit corresponding to the gradient magnetic field of three axes, it is necessary to execute measurement at least on the two axes by step 901 of the gradient magnetic field pulse waveform calculation and step 902 of the signal measurement in FIG. 9. For example, Z-axis of the gradient magnetic field is allotted to the slice-selecting gradient magnetic field axis and the remaining X and Y-axes are respectively allotted to the gradient magnetic field axis in the slice plane in the first measurement, and Y-axis of the gradient magnetic field is allotted to slice-selecting gradient magnetic field and the remaining X and Z-axes are respectively allotted to the gradient magnetic field axis in the slice plane in the second measurement. In this manner, the parameter value of the equivalent circuit with respect to X-axis and Y-axis can be obtained from the first measurement, and the parameter value of the equivalent circuit with respect to Z-axis can be obtained from the second measurement. In other words, upon searching a desired value of the parameter value of any 3 kinds of axes of the gradient magnetic field, the planar image including the axis thereof is to be used.

(Step 1008)

The combination of the parameter value in which the evaluated value calculated in step 1105 (“overshoot” or “uniformity” in the above-described example) is a desirable one is searched, and the parameter value of the equivalent circuit with respect to each of X, Y and Z of 3 axes of the gradient magnetic field at that time is outputted as a result.

The process in 1002 of FIG. 10 will be described in detail using FIG. 12.

(Step 1201)

The parameter value of the equivalent circuit is corrected by applying the parameter value to the gradient magnetic field pulse waveform inputted in step 901 of FIG. 9, and the gradient magnetic field pulse waveform after correction is obtained. More specifically, the output of the gradient magnetic field including the error element is calculated by executing convolution operation of the function wherein the transfer function representing the equivalent circuit is inverse Laplace transformed on the output of the gradient magnetic field set by the sequencer.

(Step 1202)

The coordinates on the measurement space of the echo signal are calculated by equation (2) from the gradient magnetic field waveform including the error element which is corrected in step 1201.

The steps 1201˜1202 are independently executed for each axis (X, Y and Z). While the example of calculating in order of X-axis, Y-axis and Z-axis is shown in FIG. 12, the order of calculation is not limited thereto.

The determination process of the parameter value of the equivalent circuit in pre-measurement has been described above. That is, the MRI apparatus related to the present invention comprises approximation means that approximate the output error of the gradient magnetic field with respect to three kinds of gradient magnetic fields using multiple parameter values. In concrete terms, the equivalent circuit parameter value is set as described in step 1001 so as to approximate and correct the gradient magnetic field pulse waveform in step 1002. More specifically, the approximation means approximates the output error of the gradient magnetic field based on the multiple parameter values defined by the equivalent circuit as described in step 1001. While an RCRL circuit is used for the equivalent circuit here, an RCL circuit may be used instead.

Also, the MRI apparatus related to the present invention comprises setting means that sets multiple parameter values with respect to each axis of X, Y and Z of the gradient magnetic field for approximation by the approximation means, wherein the setting means reconstructs an image while discretely changing the multiple parameters as described in step 1001, and evaluates the multiple parameters by evaluation means using the method described in step 1005. Also, the MRI apparatus related to the present invention comprises determination means that determines a desired combination of the multiple parameter values based on the evaluation result made by the evaluation means.

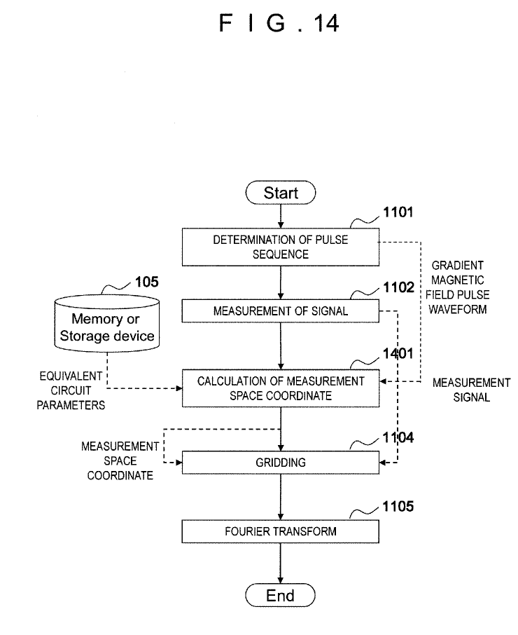

Next, the flow for applying the determined parameter value of the equivalent circuit to the main measurement will be described referring to FIG. 14. The difference from FIG. 4 is that it has step 1401 which calculates the measurement space coordinates using the parameter value of the equivalent circuit stored in memory or storage device 105.

Step 1401 reads out the parameter value of the equivalent circuit from the memory or storage device, and calculates the coordinates of the measurement space. The internal processing of step 1401 is the same as step 1002 in FIG. 10.

As described above, in accordance with the present embodiment, it is possible to obtain an image with reduced artifacts even when the imaging condition is changed in spiral scanning by acquiring the parameter value of the equivalent circuit for each axis of the gradient magnetic field by pre-measurement and reflecting the acquired values to the measurement space data of the actual measurement. The present embodiment is also effective in improving image quality in the case that the imaging cross-section is changed or the oblique imaging is executed.

### Embodiment 2

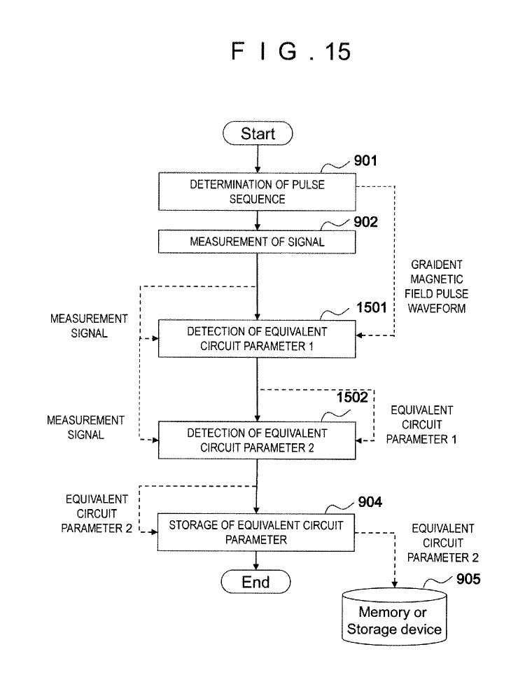

FIG. 15 shows embodiment 2 of the present invention. The difference from FIG. 9 is that embodiment 2 includes steps 1501 and 1502 for detecting two equivalent circuit parameters, and the difference from embodiment 1 is that after changing the multiple parameters by a first discrete interval, an image is reconstructed while changing the multiple parameter values at a second discrete interval which is narrower than the first discrete interval, so as to execute evaluation of the multiple parameter values.

(Step 1501)

A desired parameter value of the equivalent circuit is searched (that is, execute the process shown in FIG. 9) as in the first embodiment using the gradient magnetic field pulse waveform of the pulse sequence created in step 901 and the measurement signal measured in step 902. The acquired parameter value is set as equivalent circuit parameter value 1.

(Step 1502)

Based on equivalent circuit parameter value 1 searched in step 1501 as the reference, the parameter value of the equivalent circuit is further searched in more detailed step than step 1501. The acquired parameter value in this step is set as equivalent circuit parameter value 2. The process for this step is the same as shown in FIG. 9.

Finally, the searched equivalent circuit parameter value 2 is recorded in memory or storage device 905 in step 904.

As for the pitch to be used for searching the equivalent circuit parameter value, for example the pitch for the second searching step 1502 is set for 1/10 of the pitch to be used for the first searching step 1501. As described above, in accordance with the present embodiment, by dividing the search for the parameter value into two times and using different pitch for each time, a desired parameter value can be searched without reducing accuracy even more effectively than searching at a fine pitch from the beginning.

### Embodiment 3

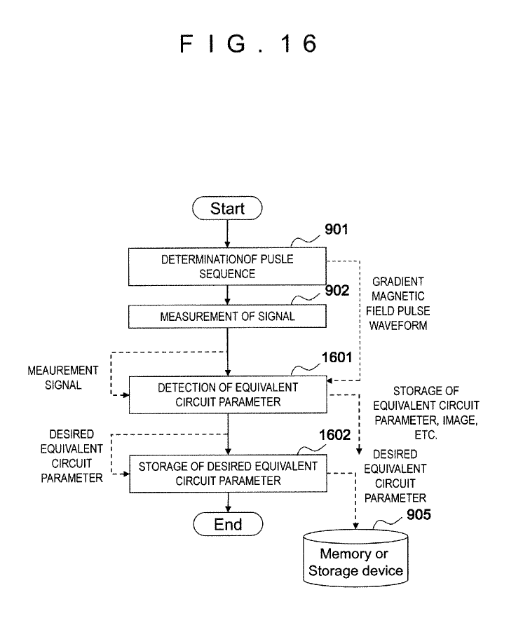

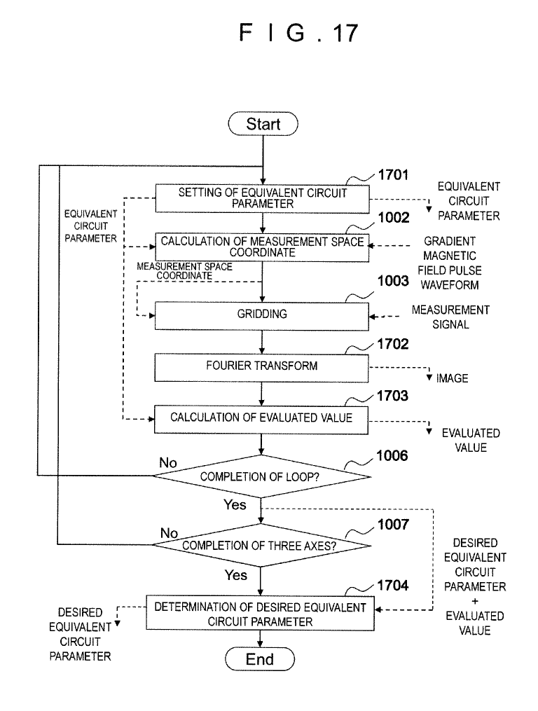

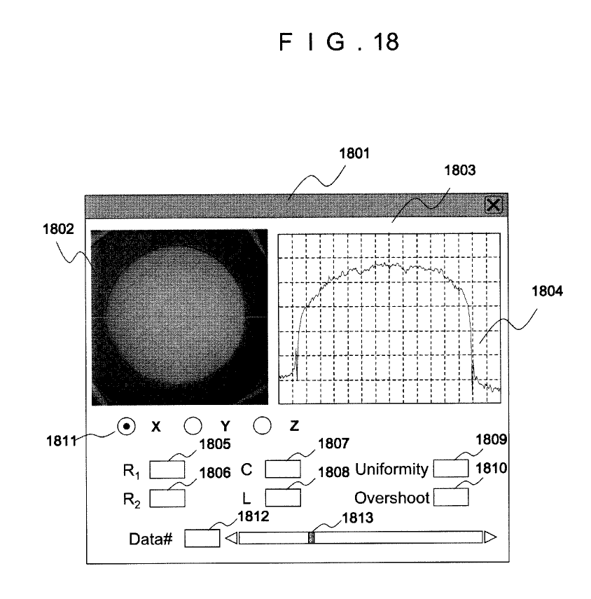

FIGS. 16˜18 show a third embodiment of the present invention. The difference from the first or second embodiments is that while a desired parameter value having an ideal evaluated value is obtained by calculating the evaluated value while discretely changing the parameter value in the first or second embodiments, the present embodiment stores the image, profile and evaluated value acquired upon each time that the parameter value is discretely changed. This procedure makes it possible later on to refer to how the image has improved in accordance with acquisition of a desired parameter value from among the changing parameter values. FIG. 16 shows the chart equivalent to FIG. 9 in embodiment 1, FIG. 17 shows the chart equivalent to FIG. 10 in embodiment 1, and FIG. 18 shows the screen that refers to the image which changes along with the parameter value. In this regard, however only the different steps will be described which are step 903 of FIG. 9 in FIG. 16, steps 1001, 1004 and 1005 of FIG. 10 in FIG. 17.

(Step 1601)

In FIG. 16, step 1601 is equivalent to step 903 of FIG. 9.

In the present step, an image is generated while arranging the echo signal measured in step 902 at the coordinates on the measurement space acquired by the parameter values in the above-described various equivalent circuits, and searches the parameter value wherein a good phantom can be acquired on the image as a desired equivalent circuit parameter value. In the present step, however the searched parameter value is stored, while changing the parameter value, in memory or storage device 905 by associating it with the image, profile and evaluated value acquired upon reconstructing the image using the parameter value.

(Step 1602)

In FIG. 16, step 1602 is equivalent to step 904 of FIG. 9.

In the present step, a desired parameter value is stored in memory or storage device 905 from among the equivalent circuit parameter values searched in step 1601.

(Step 1701)

In FIG. 17, step 1701 is equivalent to step 1001 of FIG. 10. In the present step, the concrete setting of the equivalent circuit parameter value is executed. The initial value is set at a search starting time, and the equivalent circuit parameter value is set to changing at a predetermined pitch during the search. A concrete example of the search is shown in the chart of FIG. 11. In this example, while R₁, C and L are respectively fixed as 1Ω, 1 μF and 175 μH, R₂ is set for 10 times from 0.75 Ω at 0.05Ω pitch (0.75Ω, 0.80Ω, . . . , 1.20Ω) so as to obtain a desired parameter value. Next, while R₁, R₂ and L are respectively fixed as 10, the obtained desired parameter value and 175 μH, C is set for 1Ω times from 1 μF at 1 μF pitch (1 μF, 2 μF, . . . , 10 μF) so as to obtain a desired parameter value. Finally, while R₁ is fixed as 1Ω and R₂ and C are fixed as the desired parameter values, L is set for 10 times from 175 μH at 1 μH pitch (175 μH, 176 μH, . . . , 184 μH) so as to obtain a desired parameter value. In the parameter value setting of the present step however, the setting is to be sequentially executed with respect to the parameter value for each direction of X-axis, Y-axis and Z-axis of the gradient magnetic field necessary in the MRI apparatus. The parameter value set in the present step is stored in memory or storage device 905 while associating it with the image, etc. acquired in steps 1702 and 1703 to be hereinafter described.

(Step 1702)

In FIG. 17, step 1702 is equivalent to step 1004 of FIG. 10.

More concretely, an image is generated by Fourier transforming the data which is processed with gridding. The image obtained in the present step however, is stored in memory or storage device 905 by associating it with the parameter value, etc. acquired in steps 1701 and 1703 described above or below.

(Step 1703)

In FIG. 17, step 1702 is equivalent to step 1005 of FIG. 10. More concretely, improvement of image quality due to the equivalent circuit is evaluated based on the generated image. FIG. 13 is an example of the criteria for determining image quality. FIG. 13(a) is the case of a certain combination of parameter values of an equivalent circuit, and FIG. 13(b) is the case of the other combination. The left of the diagram shows an image, and the right shows the signal intensity profile of A-A′ line in the image. Since the image has the phantom with uniform content, the signal value in the region where the phantom exists is constant in the ideal signal intensity profile. However, the signal moves up at the edge of phantom in FIG. 13(a). Also, the signal moves up high in the center area of the phantom region, and it drops down as it gets toward the outer side. At this time, the value is calculated for each parameter value of the equivalent circuit by defining the upward movement of the signal at the edge as “overshoot” and the evenness of the signal in the inner phantom as “uniformity”. For example, the average value or maximum value of the signal within the ROI set on the edge may be used for the “overshoot”, and the standard deviation of the signal within the ROI set in the phantom may be used for the “uniformity”. In other words, evaluation of the plurality of parameter values is executed in the present step based on the flatness of the magnetic resonance image of the phantom.

As acquiring desired parameter values based on the flowchart shown in FIG. 16 or FIG. 17, the image reconstructed according to the parameter value, etc. being associated with the desired parameter value are stored in memory or storage device 905.

(Step 1704)

In FIG. 17, step 1704 is equivalent to step 1008 of FIG. 10.

The parameter value having a desired evaluated value (“overshoot” or “uniformity” in the above-described example) which is calculated in step 1703 is searched, and the parameter value of the equivalent circuit with respect to the respective 3 axes which are X, Y and Z of the gradient magnetic field at that time is outputted as a result.

FIG. 18 is an example showing how the reconstructed images, etc. are changed according to the parameter value. In FIG. 18, 1801 is a window in which the result is displayed, and there are region 1802 in which the reconstructed image is displayed and region 1803 in which the data to be the index upon calculating the evaluated value from the image is displayed in window 1801. In this example, the signal intensity profile of the line indicated by a red line in image 1802 is displayed on 1804. Further, window 1801 has regions 1805˜1808 for displaying the parameter values R₁, R₂, C and L of the equivalent circuit, and regions 1809 and 1810 for displaying the values calculated as the evaluated value of the image quality described in step 1005 of embodiment 1. Here, since there are three kinds of parameter values described in 1805˜1808 which are an X-axis direction gradient magnetic field, Y-axis direction gradient magnetic field and Z-axis direction gradient magnetic field, the kind of gradient magnetic field can be switched using the tabs indicated by 1811. Also, 1812 shows the number of the parameter value combination, which is for gradually switching the display screen according to the gradual change of combination executed in step 1813.

In accordance with the present embodiment, the image and the evaluated value in the selecting process can be confirmed after a desired equivalent circuit parameter value is selected, which enables determination whether the adjustment of parameter value is adequate or not. For example, in the process of evaluating an image while sequentially changing the parameter value, it is possible to determine whether or not the reconstructed image is converged in a good condition at a comparatively early stage. By observing the degree of convergent, a clue can be gained as to search for the method for determining the initial value or the appropriate means for a further discrete change of the parameter value, and so on.

The concrete embodiments of the present invention has been described above. However, the present invention is not limited to these embodiments, and various kinds of alterations or modifications can be made within the scope of the technical idea disclosed in this application. While the spiral method of the gradient encode type is described in the present embodiment, the spiral method does not depend on the kind of pulse sequence and may also be applied to the spin echo type.

Also, while the case of the spiral method which executes sampling from the center of measurement space toward the outside is exemplified in the present embodiment, the present embodiment can also be applied to the spiral method which executes sampling from the outside of measurement space toward the center. Further, the present invention can also be applied to the spiral method which executes sampling in unspecified directions of the measurement space such as in a 3-dimensional space, or the spiral method which executes sampling from the center of measurement space toward the outside and returns to the center again.

Also, while the cases of an RCL equivalent circuit and RCRL equivalent circuit are exemplified above as the equivalent circuit for approximating the system response of the output of a gradient magnetic field, the equivalent circuit is not limited thereto. Various patterns of equivalent circuits may be applied in accordance with the system configuration.

Further, the system response of the gradient magnetic field output can be applied also to all of the pulse sequences which can be executed by an MRI apparatus, not only to the spiral method. In particular, the present invention can provide a profound effect on the improvement of image quality when applied to the sequence of which the image quality is easily influenced by the output error of gradient magnetic fields such as a radial method or echo planer method and fast spin echo method that obtain a plurality of echo signals in one time of RF irradiation.

### DESCRIPTION OF REFERENCE NUMERALS

901: setting of pulse sequence, 902 measurement of echo signal, 903: search of a desired equivalent circuit parameter, 904: storage of a desired equivalent circuit parameter, 905: memory or storage device

1. A magnetic resonance imaging apparatus comprising:
static magnetic field generation means configured to generate a static magnetic field in an imaging space in which an object to be examined is placed;
gradient magnetic field generation means configured to generate a gradient magnetic field formed in X-axis direction, Y-axis direction and Z-axis direction in the imaging space;
high-frequency magnetic field generation means configured to generate a high-frequency magnetic field in the imaging space;
reception means configured to receive a nuclear magnetic resonance signal generated from the object;
signal processing means configured to reconstruct a magnetic resonance image based on the nuclear magnetic resonance signal received by the reception means; and
control means configured to control the gradient magnetic field generation means, the high-frequency magnetic field generation means, the reception means and the signal processing means,
characterized in further comprising:
approximation means configured to approximate the output error of the gradient magnetic field with respect to the respective directions of the gradient magnetic field using the combination of multiple parameter values;
evaluation means configured to evaluate combination of the multiple parameter values based on image quality of the reconstructed magnetic resonance image considering the output error of the gradient magnetic field approximated by the approximation means; and
determination means configured to determine a desired combination from among the combinations of the multiple parameter values based on the evaluation result by the evaluation means.

2. The magnetic resonance imaging apparatus according to claim 1, wherein the approximation means approximates an output error of the gradient magnetic field based on the multiple parameter values defined by an equivalent circuit.

3. The magnetic resonance imaging apparatus according to claim 2, wherein the equivalent circuit is an RCRL circuit or an RCL circuit.

4. The magnetic resonance imaging apparatus according to claim 1, wherein the evaluation means executes evaluation of the multiple parameter values based on the flatness of a magnetic resonance image of a phantom.

5. The magnetic resonance imaging apparatus according to claim 1, characterized in comprising setting means configured to set the multiple parameter values with respect to the respective gradient magnetic fields, wherein the evaluation means reconstructs an image while discretely changing the multiple parameter values by the setting means and executes evaluation of the multiple parameter values.

6. The magnetic resonance imaging apparatus according to claim 1, characterized in comprising setting means configured to set the multiple parameter values with respect to the respective gradient magnetic fields, wherein the evaluation means changes the multiple parameter values at a first discrete interval by the setting means, then reconstructs an image while changing the multiple parameter means at a second discrete interval which is narrower than the first discrete interval, and executes evaluation of the multiple parameter values.

7. The magnetic resonance imaging apparatus according to claim 5, wherein the setting means comprises:
means that sets the initial value of the parameter value; and
changing means that changes a predetermined parameter value at predetermined interval from the initial value.

8. The magnetic resonance imaging apparatus according to claim 1, wherein the approximation means calculates the output of a gradient magnetic field considering the output error of the gradient magnetic field by performing convolution operation on the function wherein the transfer function that expresses the equivalent circuit is inverse Laplace-transformed.

9. The magnetic resonance imaging apparatus according to claim 1, wherein the magnetic resonance image is obtained by spiral scanning.

10. The magnetic resonance imaging apparatus according to claim 1, wherein the magnetic resonance image is obtained by the echo planar method.

11. The magnetic resonance imaging apparatus according to claim 1, characterized in that a desired parameter value is obtained using a planar image including the axis direction in the case that the desired parameter value of the gradient magnetic field error in any of the three kinds of axis directions is determined.

12. The magnetic resonance imaging apparatus according to claim 5, characterized in comprising display means configured to display the relationship between the change of the discrete parameter value and the image reconstructed according to the change of the parameter value.

13. The magnetic resonance imaging apparatus according to claim 5, characterized in comprising display means configured to display the relationship between the change of the discrete parameter value and the evaluated value of the image reconstructed according to the change of the parameter value.

14. A magnetic resonance imaging method for reducing artifacts generated due to the output error of gradient magnetic fields, comprising:
(1) a step that approximates the output error of the gradient magnetic field in the respective directions of the gradient magnetic field using the combination of multiple parameter values;
(2) a step that evaluates the combination of the multiple parameter values based on image quality of the reconstructed magnetic resonance image considering the output error of the gradient magnetic field approximated by the step (1); and
(3) a step that determines a desired combination from among the combinations of the multiple parameter values based on the evaluation result by the step (2).

15. The magnetic resonance imaging method according to claim 14, wherein the step (1) approximates the output error of the gradient magnetic field based on the multiple parameter values defined by an equivalent circuit.
